(19) United States
(12) Patent Application Publication
(10) Pub. No.: US 2012/0182434 A1
(43) Pub. Date: Jul. 19, 2012

(54) PHOTOGRAPHING DEVICE AND PHOTOGRAPHING CONTROL METHOD

(75) Inventor: CHONG-QING DAI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/163,740

(22) Filed: Jun. 20, 2011

(30) Foreign Application Priority Data
Jan. 18, 2011 (CN) 201110020404.3

(51) Int. Cl. H04N 5/228

(52) U.S. Cl. 348/208.4; 348/E05.042

(57) ABSTRACT

A device to take photographs and a photographing control method are provided. The device includes a processor to response to user operation to direct a distance sensor to sense a distance between the device and an object which the user intends or might want to shoot. The processor further directs a speed sensor to sense a movement speed of the device, and directs a timer to record time passing. The processor determines the photographing range of an image capturing unit according to the sensed distance and the field of view of the image capturing unit, and calculates a movement distance of the device in real time according to the sensed speed and the recorded time. The processor automatically directs the taking of a photograph when it determines that the movement distance has reached an integer multiple of the photographing range.

### BACKGROUND

1. Technical Field

The present disclosure relates to a photographing device and a photographing control method.

2. Description of Related Art

Some photographing devices which can take photographs such as cameras or mobile phones with an image capturing unit can automatically capture an image at fixed time intervals. However, such a photographing device cannot detect whether the position of a potential object for an image is changing in relation to the photographing device, and cannot automatically take an image before the perspective of the object for an image falls below an optimal perspective. This lack of an automatic function needs to be filled.

### BRIEF DESCRIPTION OF THE DRAWINGS

The components of the drawings are not necessarily drawn to scale, the emphasis instead being placed upon clearly illustrating the principles of a photographing device and a photographing method. Moreover, in the drawings, like reference numerals designate corresponding parts throughout several views.

FIG. 1 is a block diagram of a device for taking photographs in accordance with an exemplary embodiment.

FIG. 2 is a schematic view showing how to determine the photographing range of the device of FIG. 1.

FIG. 3 is a flowchart of a photographing control method in accordance with an exemplary embodiment.

### DETAILED DESCRIPTION

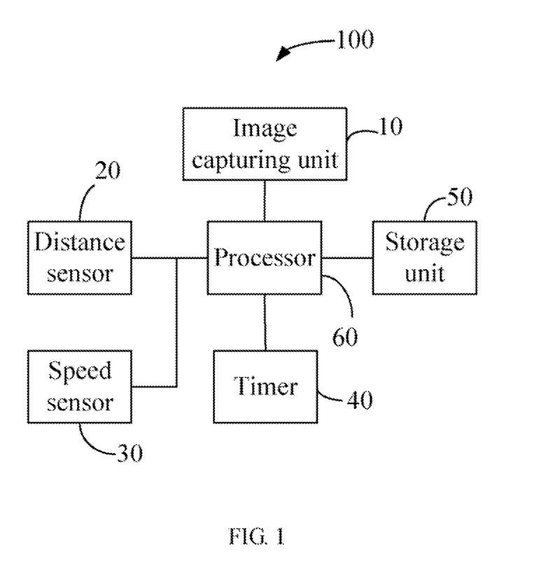

Referring to FIG. 1, a device for taking photographs (photographing device 100) includes an image capturing unit 10, a distance sensor 20, a speed sensor 30, a timer 40, a storage unit 50, and a processor 60. The photographing device 100 may be a camera or a smart phone.

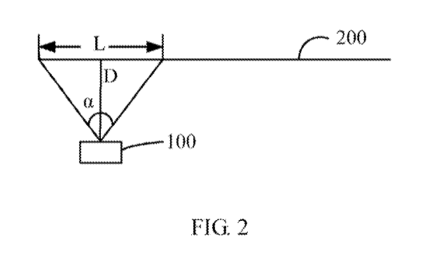

Referring to FIG. 2, the distance sensor 20 senses a distance D between the photographing device 100 and an object which a user intends to photograph or might want to photograph (object 200). In this embodiment, the distance sensor 20 may be an infrared sensor. The speed sensor 30 senses movement speed V of the photographing device 100. In this embodiment, the speed V is constant to simplify explanation. That is, a user with the photographing device 100 is assumed to move at a constant speed. The object 200 is assumed to be an object having a vertical surface, such as a large placard. Thus, when the user goes along a straight line substantially equal to the vertical surface of the object 200, the distance D is unchanged.

The processor 60 directs the distance sensor 20, the speed sensor 30, and the timer 40 to operate in response to user input. In this embodiment, the photographing device 100 may include a first button (not shown) and a second button (not shown). When the first button is pressed, the processor 60 directs the distance sensor 20 to sense the distance D. When the second button is pressed, the processor 60 directs the timer 40 to record time T passing and directs the speed sensor 50 to sense the movement speed V.

In another embodiment, all the last-mentioned functions may be simultaneously invoked by only one button.

In this embodiment, when the user is about to move along a straight line substantially parallel to the object 200, the user presses the first button. When the first button is pressed, the processor 60 activates the distance sensor 20 to sense the distance D. The processor 60 then determines a photographing range L for the image capturing unit 10 according to the formula L=2Dtgα/2 (see FIG. 2), where α is the field of view of the image capturing unit 10. After the first button is pressed, the user may move farther along the straight line. When the user begins to move again, he/she may press the second button. When the second button is pressed, the processor 60 directs the speed sensor 30 and the timer 40 to begin operating. The processor 60 then calculates a movement distance S of the photographing device 100 in real time according to the formula S=VT, and directs the image capturing unit 10 to take an image whenever the processor 60 determines that the movement distance S has reached an integer multiple of the photographing range L. When the movement distance S has reached the integer multiple of the photographing range L, the content of the image captured by the image capturing unit 10 may be completely different from a previously captured image.

The processor 60 further stores the captured images in the storage unit 50. In this embodiment, the processor 60 retrieves a number of images from the storage unit 50 in response to user input, and composes the selected images into one composite image according to the capture times of the selected images.

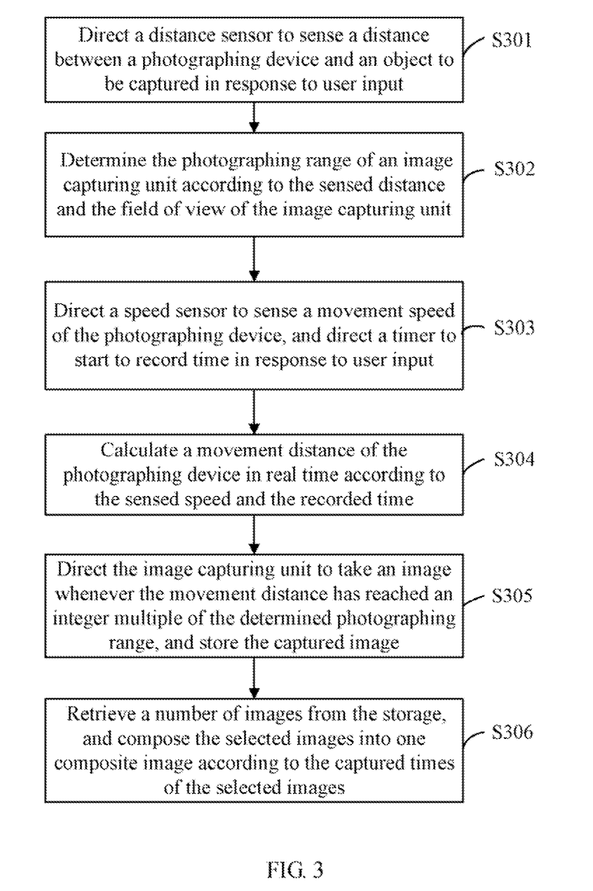

FIG. 3 is a flowchart of a photographing control method in accordance with an exemplary embodiment.

In step S301, the processor 60 directs the distance sensor 20 to sense the distance D between the photographing device 100 and the object 200 in response to user input.

In step S302, the processor 60 determines the photographing range L of the image capturing unit 10 according to the formula L=2Dtgα/2

In step S303, the processor 60 directs the timer 40 to start recording time T passing and directs the speed sensor 30 to sense the movement speed V of the photographing device 100.

In step S304, the processor 60 calculates the movement distance S of the photographing device 100 in real time according to the formula S=VT.

In step S305, the processor 60 directs the image capturing unit 10 to take an image when the processor 60 determines that the movement distance S has reached an integer multiple of the photographing range L, and stores such images as automatic captures in the storage unit 50.

In step S306, the processor 60 retrieves a number of images from the storage unit 50 in response to user input, and composes the selected images into one composite image according to the capture time of each selected image.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A device for taking photographs, comprising:
an image capturing unit;
a storage unit;
a distance sensor to sense a distance between the device and an object to be captured;
a speed sensor to sense a movement speed of the device;
a timer; and
a processor to respond to user operation to direct the distance sensor to sense the distance between the device and the object, direct the speed sensor to sense the movement speed of the device, and direct the timer to record time passing, the processor further to determine a photographing range of the image capturing unit according to the sensed distance and the field of view of the image capturing unit, calculate a movement distance of the device in real time according to the sensed speed and the recorded time, and control the image capturing unit to take an image whenever the movement distance of the device has reached an integer multiple of the photographing range, and further to store the captured image in the storage unit.

2. The device as described in claim 1, wherein the processor is further to respond to user input to retrieve a plurality of images from the storage unit, and compose the plurality of images into one composite image according to the captured times of the plurality of images.

3. The device as described in claim 1, wherein the distance sensor is an infrared sensor.

4. A photographing method applied in a device for taking photographs, the device comprising a storage unit, an image capturing unit, a distance sensor, a speed sensor, and a timer, the method comprising:
directing the distance sensor to sense a distance between the device and an object to be captured in response to user input;
determining a photographing range of the image capturing unit according to the sensed distance and the field of view of the image capturing unit;
directing the speed sensor to sense a movement speed of the device, and directing the timer to record time passing in response to user input;
calculating a movement distance of the device in real time according to the sensed speed and the recorded time;
directing the image capturing unit to take an image whenever the movement distance of the device has reached an integer multiple of the determined photographing range; and
storing the captured image in the storage unit.

5. The photographing method as described in claim 4, further comprising:
retrieving a plurality of images from the storage unit in response to user input, and composing the plurality of images into one composite image according to the captured times of the plurality of images.
